(19) United States
(12) Patent Application Publication
(10) Pub. No.: US 2011/0086335 A1
(43) Pub. Date: Apr. 14, 2011

(54) WEAR AND WRITE DRY-ERASE NOTEPAD

(76) Inventor: Michael H. Rogers, Baltimore, MD (US)

(21) Appl. No.: 12/898,065

(22) Filed: Oct. 5, 2010

Related U.S. Application Data
(60) Provisional application No. 61/340,012, filed on Mar. 12, 2010.
(60) Provisional application No. 61/278,792, filed on Oct. 13, 2009.

(51) Int. Cl. B43L 1/00; B43K 29/00

(52) U.S. Cl. 434/408; 401/195; 401/131

(57) ABSTRACT

A portable dry erase notepad for instantly jotting down notes, daily tasks, measurements for engineering and construction, grocery lists, phone numbers, e-mail and home addresses, sketches, etc. while in the car, in the workplace, in class; and at a meeting, party, or any event. The portable dry erase notepad includes a note screen comprises a rectangular panel of dry erase material with rounded edges and or a material being metallic or plastic with a gloss-white dry-erase coating. The note screen is framed in a leather or vinyl faux leather exterior cover that securely seats the note screen leaving the clear or white dry-erase surface exposed. An elastic loop is sewn into the margins of the exterior cover for securing a dry erase marker pen alongside. The dry erase marker pen is equipped with an eraser. The backside of the exterior cover is selectively equipped with a variety of attachment mechanisms, primarily an elastic fabric cuff with hook and look insets for secure wrist-attachment, though a belt clip and/or retractable tether are also provided. The portable dry erase notepad is aesthetically and looks good on the wrist or body, even with the integral marker docked thereto for convenient access, and offers an instant resource for jotting down notes, daily tasks, grocery lists, phone numbers, e-mail and home addresses, measurements or sketches, etc. virtually anywhere.

### CROSS-REFERENCE TO RELATED APPLICATION(S)

The present application derives priority from U.S. provisional application Nos. 61/340,012 filed Mar. 12, 2010 and 61/278,792 filed Oct. 13, 2009.

### BACKGROUND OF THE INVENTION

1. Field of the Invention

The present invention relates to a wearable dry erase notepad, and more particularly to a wrist-worn notepad for spontaneous note taking that generally comprises a portable erasable marking pad and pen combination for handwritten note entry, and wristband-attachment for convenient wrist-borne access to both the marking pad and pen.

2. Description of the Background

When thoughts run through an individual's head it is sometimes useful to jot them down so as not to forget them. For example, in the car, in line at a store, or at work, an individual may remember tasks that he has to complete, groceries he needs to purchase, or information that needs to be remembered, and he will scribble notes on a napkin or sheet of paper and stuff it in a pocket. Pocket notes and loose sheets of paper are too easily misplaced, and seldom available when later needed. Other times, such as when taking measurements for building something, it would be helpful to write to down the measurements, but a sheet of paper and a pen may not be handy to write with. It would be greatly advantageous to provide an alternative to paper notes by offering a portable device for note entry that is readily available for jotting down thoughts, measurements or other information at any time.

A number of electronic solutions exist in this regard. For example, U.S. Pat. Nos. 6,806,867, 5,237,651, 5,444,192 and U.S. Patent Application Publication Nos. US20020173345 and 20040001093 are directed toward taking electronic notes. While these electronic note-taking devices have furthered technological development, they are too complex in design and function with multiple tools, menus, etc., all of which are cumbersome and difficult for an average user who simply desires to take notes to use. Electronic devices require an extensive knowledge of the device to retrieve notes and utilize recently recorded information. Typically, the user must flip open an electronic device, navigate menus, and find a note recorded just hours earlier, thereby discouraging users from utilizing the notes function of the electronic devices. Also, these devices are either too small for taking notes or are too bulky to fit within a pocket/lapel, and are expensive for users who desire only to jot down short notes. Additionally, because these devices are complex in function as well as in hardware they are impractical and laborious to use.

Thus, there remains a need for a portable erasable marking pad and pen combination for handwritten note entry, and wristband-attachment for convenient wrist or body-borne access to both the marking pad and pen, that is readily available for jotting down thoughts, measurements or other information at any time.

### SUMMARY OF THE INVENTION

It is an object of the present invention to provide a wrist or body-worn dry erase notepad for instantly jotting down notes, daily tasks, grocery lists, phone numbers, e-mail and home addresses, sketches, measurements, etc. while in the car, at work, in class; and at a meeting, party, or any event.

Another object of the present invention is to provide an aesthetically pleasing dry-erase notepad that looks good on the wrist or body, and which docks an integral marker for convenient access.

Another object of the present invention is to provide a dry-erase wrist-worn notepad that can be easily removed from the wrist and alternatively carried via belt clip or retractable tether. Still another object of the present invention is to provide a dry erase notepad with dry erase pen that can be removed from a dock and adhered directly to the dry-erase screen with Velcro™, tape, or magnets.

It is still another object of the present invention is to provide a dry-erase notepad with all the foregoing qualities and yet that is inexpensive to manufacture and sell to provide for widespread use.

In accordance with the foregoing objects, the present invention is a portable dry erase notepad for instantly jotting down notes, measurements for assembly and construction, daily tasks, grocery lists, phone numbers, e-mail and home addresses, sketches, etc. while in the car, while in the workplace, in class; and at a meeting, party, or any event. The portable dry erase notepad includes a note screen comprising approximately 3″ by 2.5″ rectangular dry erase panel with rounded edges. The dry erase panel is formed from a dry erase surface coated or laminated over a vinyl layer (white or light with printed logo). The dry erase surface preferably comprises a clear or opaque polyurethane film layer of 0.003-0.008 inches thick which allows for the placement of graphics such as logos beneath on the plastic or vinyl layer, or alternatively a solid gloss-white dry erase material where logos/graphics are not desired. Rather than a film, the dry erase surface may comprise a dry erase coating such as white or clear urethane lacquer or acrylic. The note screen is framed in a leather or vinyl faux leather exterior cover that securely seats the note screen leaving the dry-erase surface exposed. An elastic loop is sewn into the margins of the exterior cover for securing a dry erase marker pen alongside. The dry erase marker pen is equipped with a magnetic or Velcro™ cap and can thereby be magnetically or mechanically adhered directly to the note screen or framing cover. The backside of the exterior cover is selectively equipped with one or more body attachment mechanisms, primarily an elastic fabric cuff with hook and loop insets for secure wrist-attachment. Alternatively (or in addition), a belt clip and/or retractable tether are provided for wearing on a belt, pocket, tool belt, purse, or tape measure, respectively.

The portable dry erase notepad is aesthetically complimentary to a person's dress or work uniform and looks good on the wrist, belt, pocket, etc., even with the integral marker docked thereto for convenient access, and offers an instant resource for jotting down notes, daily tasks, grocery lists, phone numbers, e-mail and home addresses, measurements or sketches, etc. virtually anywhere.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a front perspective view of the wrist-worn notepad 1 worn on a wrist according to a preferred embodiment of the present invention.

FIG. 2 is a front view of the wrist-worn notepad 1 as in FIG. 1.

FIG. 3 is an exploded perspective view illustrating the construction details of the wrist-worn notepad 1 of FIGS. 1-2.

FIG. 4 is a rear perspective view of the wrist-worn notepad 1 of FIGS. 1-3 with the addition of a belt clip 50.

FIG. 5 is a rear perspective view of the wrist-worn notepad 1 of FIGS. 1-3 with the addition of a retractable reel holder 60.

FIG. 6 is a front perspective view illustrating how the wrist-worn notepad 1 is attached to the belt by belt clip 50.

FIG. 7 is a front perspective view illustrating how the wrist-worn notepad 1 is attached to the belt by retractable reel holder 60.

FIG. 8 is a perspective view of the wrist-worn notepad 1 with a translucent front cover 70.

FIG. 9 is a perspective view of the wrist-worn notepad 1 with clamshell secondary note screen.

FIG. 10 is a perspective view of the wrist-worn notepad 1 illustrating how the cover 70 of FIG. 8 may be equipped with a business card slot for marketing purposes.

### DETAILED DESCRIPTION OF THE PREFERRED EMBODIMENT

The present invention is a wrist and or body-worn notepad and pen combination that is compact, lightweight, portable, and readily useable for taking erasable handwritten notes.

FIG. 1 is a front perspective view of the wrist-worn notepad 1 worn on a wrist according to a preferred embodiment of the present invention. The wrist-worn notepad 1 allows a user to instantly capture everything the user handwrites onto a dry-erase note screen 10 using an integral dry erase marking pen 20. The wrist-worn notepad 1 is especially useful for jotting down notes, daily tasks, grocery lists, phone numbers, e-mail and home addresses, measurements, etc. while in the car, in class, at a worksite, or at other events. Part of the utility of the device resides in an array of different pen 20 attachment mechanisms, including an elastic fabric loop 34 for docking the pen 20 when not in use, a magnetic strip 14 embedded in the note screen 10 for temporarily adhering the pen 20 via its magnetic cap 24 when in use, and hook and loop attachment pads 16. Loop, Velcro™ or magnetic are three ways of attaching pen.

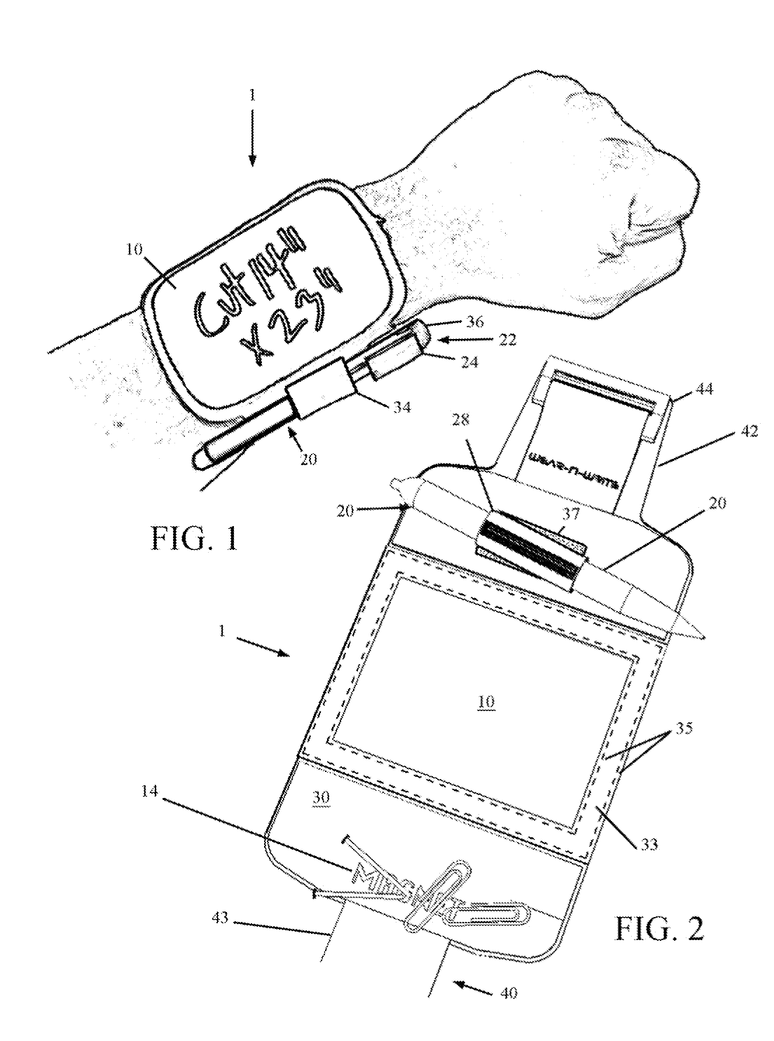

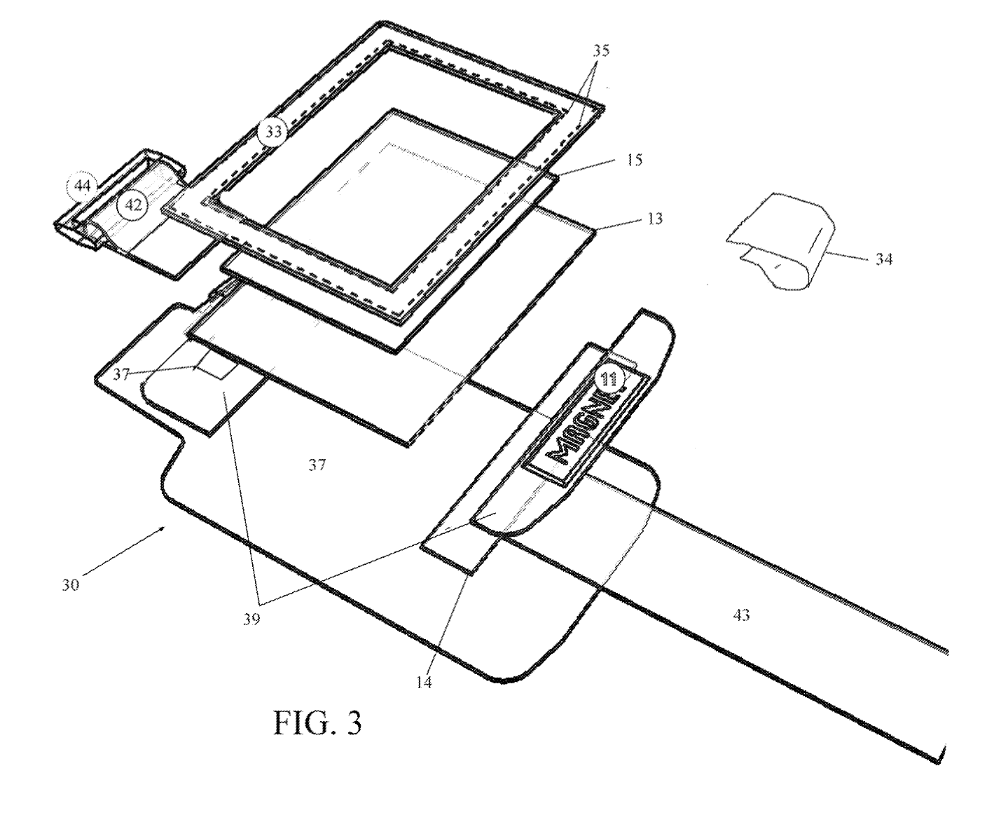

FIG. 2 is an enlarged front view of the wrist-worn notepad 1 as in FIG. 1. The note screen 10 comprises approximately a 3″ by 2.5″ rectangular dry erase panel with rounded corners formed of a section of substantially rigid rectangular sheet (see FIG. 3 plastic sheet section 13), preferably plastic or vinyl, although a metallic sheet may be used for its magnetic properties. The plastic sheet section 13 is preferably white and is coated or layered with a clear dry erase layer (see FIG. 3 dry-erase layer 15) to add contrast to the pen markings as seen in FIG. 1. Alternatively, the plastic sheet section 13 may be printed with a multi-colored graphic design such as a logo to show through the clear dry erase layer 15. As yet another alternative, the sheet section 13 may be a metal or darker-colored plastic, in which case the dry erase layer 15 may be white. The note screen 10 (including both plastic sheet section 13 and dry erase layer 15) is held within a cover skin 30 that completely covers the note screen 10 on its backside and frames the note screen 10 on its front side, leaving the dry-erase layer 15 exposed. The particular sandwiched-construction details of the cover skin 30 are important to functionality and are described below with reference to FIG. 3. Generally, the cover skin 30 comprises two opposing layers of leather, faux leather vinyl, or neoprene fabric sewn and/or bonded together, one layer being cut centrally to form a rectangular window for recessed seating of the note screen 10 therein. The cut-and-removed window section of the cover skin top layer 30 is cut again with its own rectangular window to define a rectangular frame 33, and this frame 33 is placed over the note screen 10. A double-sewn seam 35 penetrates and surrounds all of the frame 33, note screen 10, and backside of the cover skin to securely affix all layers together in a sandwiched structure. An elastic fabric loop 34 is secured peripherally to the cover skin 30 for docking the dry erase marker pen 20, and pen 20 slides within the fabric loop 34 as seen in FIG. 1 for docking when not in use. Alternately, if the user wishes to temporarily park the pen 20, a magnetic strip 14 is embedded (sewn or bonded) between the layers of the cover skin 30.

Pen 20 includes a conventional dry erase marker handle, writing tip, and dry-erase ink reservoir, and preferably includes cap 22 which is removably attached to the marker 20 and covers the writing tip when not in use. Cap 24 may have a rectangular eraser 36 suitable for erasing markings from the note pad 10. The eraser 36 is preferably comprised of a configuration of a standard dry erase board eraser.

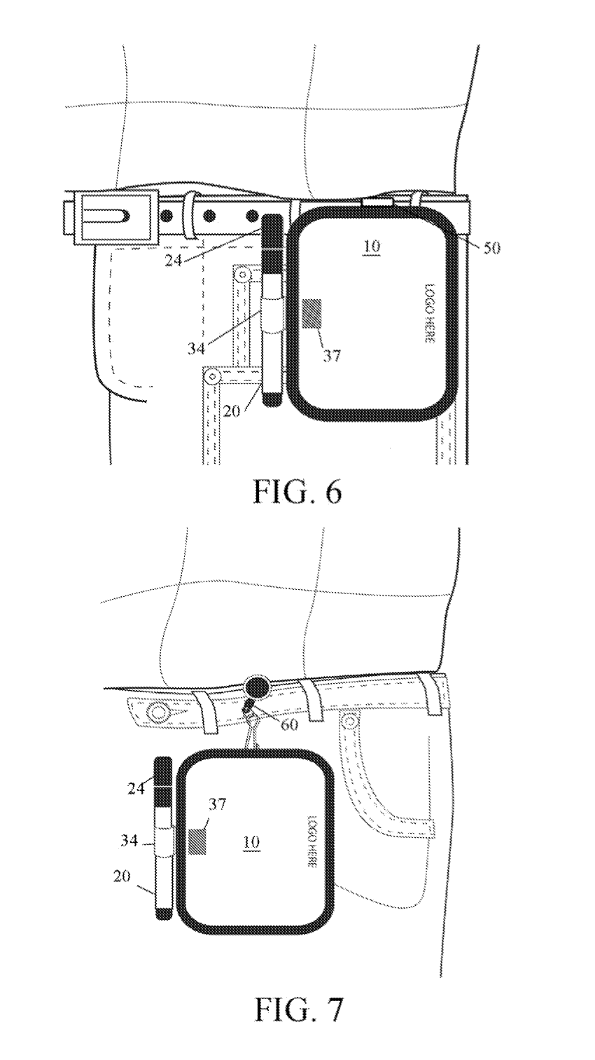

The cap of pen 20 is also equipped with a like-sized and cooperating metal strip/magnet 36 for temporarily adhering the pen 20 magnetically to magnet 14 beneath the note screen 10. The magnet 14 may also be used to adhere nails for construction (as shown in FIG. 2), paper clips, etc. As still a third alternative, the pen 20 is equipped with a hook-and-loop jacket 28, in which case a cooperating section of hook-and-loop material 37 is adhered to one of the side flaps of the cover skin 30, the notepad 10 itself (see FIGS. 6-7), or elsewhere, thereby giving the user three different ways of attaching pen 30 as a matter of preference.

In the illustrated embodiment a wrist cuff 40 is formed by a first band section 42 protruding sidelong from between the layers of cover skin 30, an opposing second band section 43, and a cinch buckle 44 attached distally to one of the two. Alternatively, the buckle 40 may be replaced by hook-and-loop attachment fixtures. In addition, rather than separate sections 42, 43, the backside of the cover skin 30 may be equipped with a unitary elongate elastic fabric strap extending between a first and a second end, and fixedly attached mid-length to the backside of the cover skin 30, and likewise having a cinch buckle or hook and loop insets at each end for secure wrist-attachment. Opposite the embedded magnet 24, cap 22 may also include a small rectangular dry eraser 36 suitable for erasing markings from the note pad 10. The eraser 36 may be adhered within a rectangular receptacle on one side of the cap 24 as shown for magnet 24, or alternatively to the end of the marker 20 distal to the writing tip.

FIG. 3 is an exploded perspective view illustrating the construction details of the wrist-worn notepad 1 as in FIGS. 1-2. The white plastic sheet section 13 and clear dry-erase coating layer 15 which together form note screen 10 are held within the cover skin 30, the backside layer of leather, faux leather vinyl, or neoprene fabric completely covering the entire backside of the note screen 10. The front side layer of fabric may initially conform to the back, but is cut centrally to form two opposing flaps 39 spaced by a rectangular window for recessed seating of the note screen 10 therein. The rectangular frame 33 is placed over the note screen 10, and a double-sewn seam 35 is sewn through all of the frame 33, note screen 10, and backside of the cover skin to securely affix all layers together in a sandwiched structure, while still leaving the dry-erase layer frontally exposed. This sandwiched-construction results in a lowest-profile device 1 for added comfort, convenience and improved aesthetics. The ends of the elastic fabric loop 34 for docking the dry erase marker pen 20 are sandwiched between the frame 33 and one of flaps 39 to allow the loop to protrude, and the magnetic strip 14 is sewn beneath one of the flaps 39 as shown. The section of hook-and-loop material 37 for attachment of pen 20 is adhered to the front of one of flaps 39. The first band section 42 of wrist cuff 40 protrudes sideward from between the backside layer 37 of cover skin 30 and a flap 39 and is bonded and/or sewn there between. The same is true of the second band section 43 on the other side. The first band section 42 protrudes outward to a cinch buckle 44 and is looped thereabout, attached onto itself to anchor the buckle 44 thereto at a fizzed distance. Alternatively, the buckle 40 may be replaced by hook-and-loop attachment fixtures. In addition, the wrist cuff 40 may comprise approximately a 6″ length of 2.5″ wide stretch fabric such as Lycra™ or Spandex™, adhered or sewn to the backside 37 of cover skin 30. In this case, the elastic fabric strap extends between a first and a second end, and is fixedly attached mid-length to the backside of the cover skin 30, and is equipped with hook and loop insets. Preferably, the loop material runs a majority of the length, running continuously left to approximately 1″ shy of the right-hand end, and the 1″ right-hand end instead bears an inset of hook material. Given buckle 44 at the other end this allows the wrist cuff 40 to be tightened and secured about the buckle 44. In any of the foregoing cases the wrist cuff 40 may be secured around the user's wrist simply by wrapping the free end around the wrist and securing the free end, securing the note screen 10 exposed atop the user's wrist. The user can easily remove the marking pen 20 from its fabric loop 34 and write on the note screen 10.

The hook-and-loop section 37 on one side and magnetic strip 14 on the other side allows the marking pen 20 to be temporarily adhered directly to the front of the device 1 to free a hand, such as for a sip of coffee. When finished taking notes, the user can just as easily replace the marking pen 20 in its fabric loop 34.

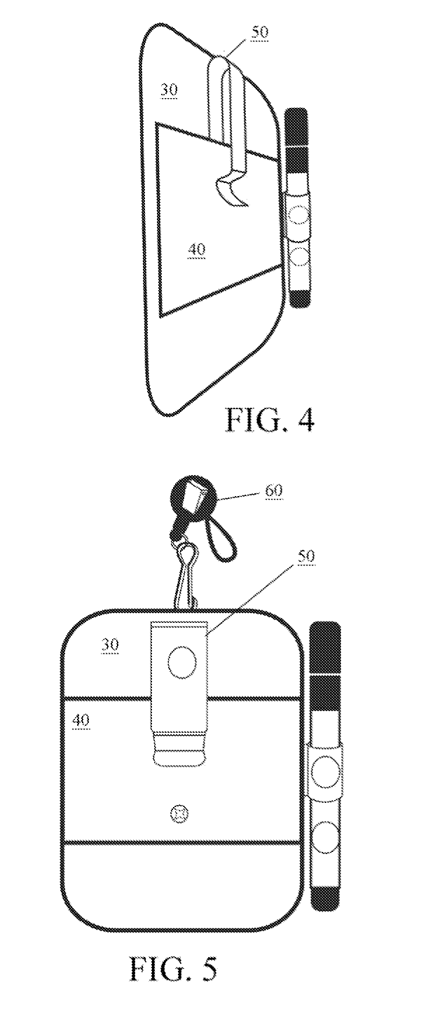

FIG. 4 is a rear perspective view of the wrist-worn notepad 1 of FIGS. 1-3 with the addition of a belt clip 50, and FIG. 5 is a rear view with belt clip 50 and a retractable reel holder 60, both belt clip 50 and reel 60 being attached as alternatives to the wrist cuff 40 attachment. Belt clip 50 is a conventional resilient belt clip that is removably secured to the backside of the exterior cover 30. Retractable reel holder 60 is a conventional spring-loaded retractable tether as commonly used for key fobs and the like, and this is attached to a second fabric loop sewn into the margins of the exterior cover 30.

As seen in FIGS. 6-7, belt clip 50 allows convenient alternate wearing on the belt, while retractable reel holder 60 allows attachment to a belt, belt loop, pocket or purse, etc.

One skilled in the art should understand that the note pad 10 may be comprised of various shapes rather than the preferred embodiment, such as but not limited to square, circular and triangular.

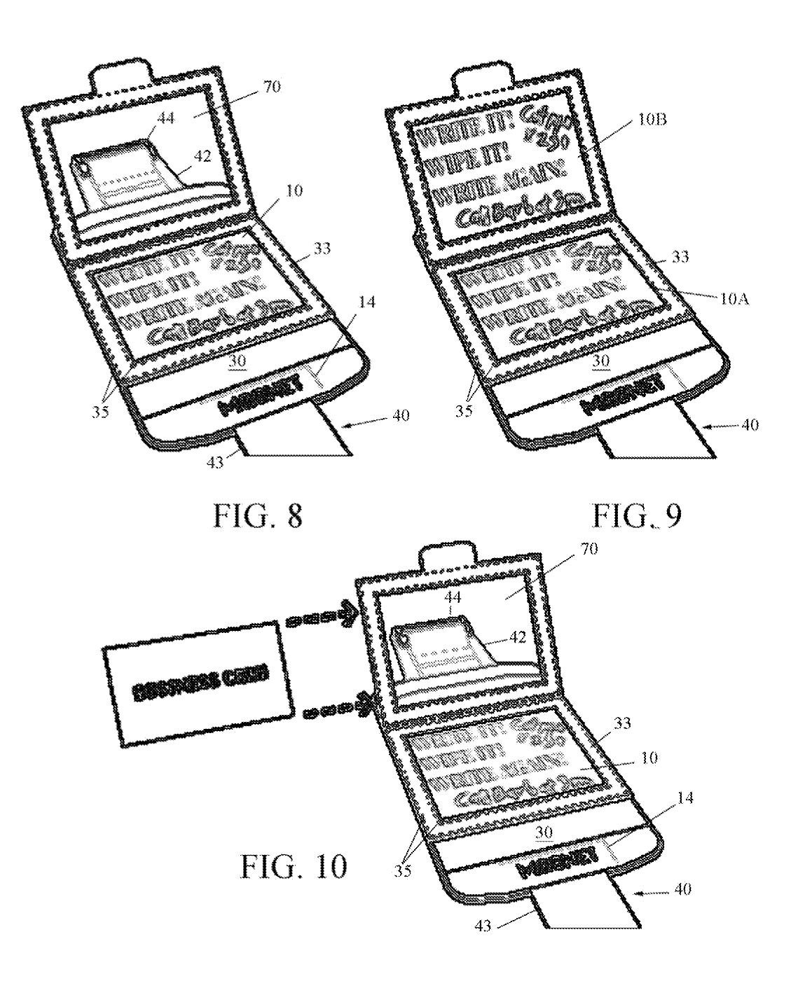

FIGS. 8-10 illustrate several design options, including a translucent front cover 70 (FIG. 8) which may be pivotally attached to the note screen 10 to protect its dry erase qualities and to prevent smudging of the markings. Rather than a translucent cover, a second note screen 10B may be may be pivotally attached to the first note screen 10A (FIG. 9) to provide a larger marking surface by clamshell operation. FIG. 10 illustrates how the cover 70 of FIG. 8 may be equipped with a business card slot for marketing purposes.

In all the above-described embodiments, the wrist or body-worn dry erase notepad 1 allows instant jotting down of notes, daily tasks, grocery lists, phone numbers, e-mail and home addresses, sketches, measurements, etc. while in the car, at work, in class; and at a meeting, party, or any event, and provides an aesthetically pleasing look and comfortable low-profile feel. It also has extreme flexibility in that it can be easily removed from the wrist and alternatively carried via belt clip or retractable tether, and the pen 20 can be placed in various positions for storage. Owing to its sandwich construction the dry-erase notepad 1 is inexpensive to manufacture and sell to provide for widespread use.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed:

1. A wrist and body-worn writing system comprising:
a dry erase note pad including at least one dry erase writable surface;
a fabric case enveloping said note pad fully on a backside, continuously along its edges, and partially on a front side leaving an open window to said dry erase writable surface;
a fabric loop attached to said fabric case;
a dry erase marker held captive in said loop;
a wrist cuff attached to said fabric frame.

2. The wrist and body-worn writing system according to claim 1, further comprising a belt clip attached to the backside of said fabric case.

3. The wrist and body-worn writing system according to claim 2, further comprising a retractable tether reel attached to said fabric case.

4. The wrist and body-worn writing system according to claim 1, further comprising a belt clip attached to the backside of said fabric case.

5. The wrist and body-worn writing system according to claim 1, wherein said dry erase note pad comprises a plurality of layers including one of a vinyl layer or a plastic layer and a dry erase polyurethane film layer in a range of between 0.003-0.008 inches thick atop said vinyl or plastic layer.

6. The wrist and body-worn writing system according to claim 5, wherein said vinyl layer or said plastic layer are white and said dry erase polyurethane film is translucent.

7. The wrist and body-worn writing system according to claim 1, wherein said dry erase note pad comprises a plurality of layers including one of a vinyl layer or a plastic layer and one of a dry erase urethane lacquer or acrylic coating atop said vinyl or plastic layer.

8. The wrist and body-worn writing system according to claim 7, wherein said vinyl layer or said plastic layer are white and said dry erase coating is translucent.

9. The wrist and body-worn writing system according to claim 7, wherein said dry erase coating is white.

10. The wrist and body-worn writing system according to claim 1, wherein said dry erase marker includes a cap having a magnet attached thereto.

11. The wrist and body-worn writing system according to claim 1, wherein said fabric case contains a magnet sandwiched therein.

12. The wrist and body-worn writing system according to claim 1, wherein said dry erase marker includes a first section of hook-or-loop material attached thereto.

13. The wrist and body-worn writing system according to claim 1, further comprising a second section of hook-and-loop material attached externally to said fabric case for adhering to the first section of hook-or-loop material attached to the dry erase marker.

14. The wrist and body-worn writing system according to claim 1, wherein said fabric case comprises a first layer of fabric completely covering a backside of said dry erase note pad, and a pair of opposing flaps flanking said dry erase note pad, said dry erase note pad being recessed between said flaps.

15. The wrist and body-worn writing system according to claim 14, further comprising a second framing layer of fabric conforming to said dry erase note pad, seated between said flaps, and having an open window exposing a majority of said dry erase note pad.

16. The wrist and body-worn writing system according to claim 15, further comprising stitching through all of said first layer of fabric, dry erase note pad, and second framing layer of fabric.

17. The wrist and body-worn writing system according to claim 15, wherein said wrist cuff further comprises a first strap sandwiched between said first layer of fabric and said second framing layer of fabric and extending from one end of said fabric case, and a second strap sandwiched between said first layer of fabric and said second framing layer of fabric and extending from another end of said fabric case.

18. The wrist and body-worn writing system according to claim 1, wherein said wrist cuff further comprises a continuous strap attached to the backside of said fabric case.

19. The wrist and body-worn writing system according to claim 1, wherein said wrist cuff first strap is attached to a cinch buckle at its distal end.

20. The wrist and body-worn writing system according to claim 18, wherein said wrist cuff continuous strap has mating sections of hook-and-loop material at its distal ends.

21. The wrist and body-worn writing system according to claim 1, further comprising a transparent cover hinged on one side of said note pad for covering said window.

22. The wrist and body-worn writing system according to claim 21, wherein said cover is defined by a slot for insertion of a card.

23. The wrist and body-worn writing system according to claim 21, wherein said hinged cover further comprises a second dry erase note pad mounted thereon.

24. A portable dry erase notepad for jotting down information, comprising:
a note screen formed of a substantially rigid rectangular panel having a top-to-bottom dimension, a side-to-side dimension longer than said top-to-bottom dimension, a backside, peripheral edges, and a front side, the front side being covered by one of a white or clear dry erase layer;
a cover skin framing the note screen yet leaving the dry-erase surface exposed, said cover skin further comprising an uninterrupted layer covering the backside of said rectangular note screen, and a window layer partially covering and partially exposing a portion of the front side of said rectangular note screen;
a sewn seam continuously penetrating the backside layer of said cover skin proximate the peripheral edges of said note screen, the note screen, and said window layer;
a dry erase marker pen having a cap and a magnet affixed to said cap;
an elastic fabric loop secured peripherally to said cover skin for docking said dry erase marker pen; and
an elastic fabric cuff defined by opposing straps extending outward from said note pad parallel to said top-to-bottom dimension for secure wrist-attachment.

25. The portable dry erase notepad according to claim 24, further comprising a belt clip attached to the backside of said fabric case.

26. The wrist and body-worn writing system according to claim 24, further comprising a retractable tether reel attached to said cover skin.

27. The portable dry erase notepad according to claim 24, wherein said dry erase note pad comprises a plurality of layers including one of a vinyl layer or a plastic layer and a dry erase polyurethane film layer in a range of between 0.003-0.008 inches thick atop said vinyl or plastic layer.

28. The portable dry erase notepad according to claim 24, wherein said dry erase note pad comprises a plurality of layers including one of a vinyl layer or a plastic layer and one of a dry erase urethane lacquer or acrylic coating atop said vinyl or plastic layer.

29. The portable dry erase notepad according to claim 24, wherein said dry erase marker includes a cap having a magnet attached thereto, and said skin cover contains a magnet sandwiched therein.

30. The portable dry erase notepad according to claim 24, wherein said dry erase marker includes a first section of hook-or-loop material attached thereto, and a second section of hook-and-loop material is attached externally to said skin cover for adhering to the first section of hook-or-loop material attached to the dry erase marker.

31. The portable dry erase notepad according to claim 24, wherein said skin cover comprises a first layer of fabric completely covering a backside of said dry erase note pad, and a pair of opposing flaps flanking said dry erase note pad, said dry erase note pad being recessed between said flaps.

32. The portable dry erase notepad according to claim 31, wherein said skin cover further comprises a second framing layer of fabric conforming to said dry erase note pad, seated between said flaps, and having an open window exposing a majority of said dry erase note pad.

33. The portable dry erase notepad according to claim 32, further comprising stitching through all of said first layer of fabric, dry erase note pad, and second framing layer of fabric.

34. The portable dry erase notepad according to claim 33, wherein said wrist cuff further comprises a first strap sandwiched between said first layer of fabric and said second framing layer of fabric and extending from one end of said fabric case, and a second strap sandwiched between said first layer of fabric and said second framing layer of fabric and extending from another end of said fabric case.

35. The portable dry erase notepad according to claim 24, wherein said wrist cuff further comprises a continuous strap attached to the backside of said fabric case.

36. The portable dry erase notepad according to claim 24, further comprising a transparent cover hinged on one side of said note pad for covering said window.

37. The wrist and body-worn writing system according to claim 36, wherein said hinged cover further comprises a second dry erase note pad mounted thereon.
